(19) United States
(12) Patent Application Publication
(10) Pub. No.: US 2026/0329554 A1
(43) Pub. Date: Oct. 22, 2026

(54) MALWARE ANALYSIS SYSTEM AND MALWARE ANALYSIS METHOD

(71) Applicant: Hitachi, Ltd., Tokyo (JP)

(72) Inventors: Goki HANAWA, Tokyo (JP); Rei YAMAGISHI, Tokyo (JP); Shota FUJII, Tokyo (JP); Nobutaka KAWAGUCHI, Tokyo (JP)

(73) Assignee: Hitachi, Ltd., Tokyo (JP)

(21) Appl. No.: 19/542,395

(22) Filed: Feb. 17, 2026

(30) Foreign Application Priority Data
Apr. 16, 2025 (JP) 2025-067622

(51) Int. Cl. G06F 8/35; G06F 21/56

(52) U.S. Cl. CPC G06F 8/35; G06F 21/56

(57) ABSTRACT

An aspect of the present invention is a malware analysis system including: a screen acquisition unit, an event recognition unit, a content comprehension unit, a procedure extraction unit, and a code generation unit that are implemented by a CPU; and an execution history table and a code table that are held by a storage unit, in which the code table holds a code required for malware execution and corresponding to a behavior pattern and a variable, and, when acquiring an analysis screen to be analyzed, the screen acquisition unit stores the acquired analysis screen and an acquisition time thereof in the execution history table, and the event recognition unit references the execution history table to acquire information indicating whether an event corresponding to the analysis screen stored by the screen acquisition unit is a malware-derived event, and notifies the content comprehension unit when the event is the malware-derived event.

### BACKGROUND OF THE INVENTION

The present invention relates to a system and a method for analyzing malware.

Malware used in cyber attacks is becoming increasingly sophisticated to pose a serious threat to companies and nations. Under such circumstances, it is important to analyze malware, and take proactive countermeasures.

Meanwhile, the number and types of malware are on the rise, and accordingly there is a limit to the number of malware items that can manually be analyzed by an analyst. Therefore, it is common to use an automatic analysis system to acquire summary information about malware, and then selectively determine whether or not an analyst further performs detailed manual analysis.

In view of the current situation described above, an automatic analysis system is widely used in malware analysis.

The automatic analysis system needs to have the function of performing an appropriate automatic operation on a reaction requested from a user by a malware graphic user interface (GUI). In this regard, the technology described in Japanese Translation of PCT Application No. 2018-501583 is known.

Japanese Translation of PCT Application No. 2018-501583 describes that an automatic operation is performed on the basis of an action profile including a collection of instructions and commands for performing a user interaction (UI) action associated with a specific type of object determined in advance.

### SUMMARY OF THE INVENTION

There is malware which displays a GUI that requests any reaction from a user (hereinafter referred to as the event). There are various examples of the event and the requested reaction, including a click on a “Yes” button in a dialog, a click on an “Enable editing” button in a file with macro, key input on a password input screen, and the like.

When there is no appropriate reaction to the event, it may be possible that the malware halts midway, analysis does not proceed, and the analyst cannot acquire required malware information.

Accordingly, it is necessary to produce an automation program that precisely acquires requested reactions for a wide variety of events, and automatically operate appropriate reactions.

In Japanese Translation of PCT Application No. 2018-501583, an operation procedure is determined using a rule-based method on the basis of the action profile determined in advance, and the automatic operation is performed. Therefore, it is not always possible to obtain an automation program that appropriately reacts to malware that requests an operation not determined in the action profile.

The present invention has been achieved on the basis of such background, and provides a system and a method that precisely acquire requested reactions for a wide variety of malware events, and automatically operate appropriate reactions.

An aspect of the present invention is a malware analysis system including: a screen acquisition unit, an event recognition unit, a content comprehension unit, a procedure extraction unit, and a code generation unit that are implemented by a CPU; and an execution history table and a code table that are held by a storage unit. The code table holds a code required for malware execution and corresponding to a behavior pattern and a variable. When acquiring an analysis screen to be analyzed, the screen acquisition unit stores the acquired analysis screen and an acquisition time thereof in the execution history table. The event recognition unit references the execution history table to acquire information indicating whether or not an event corresponding to the analysis screen stored by the screen acquisition unit is a malware-derived event, and notifies the content comprehension unit when the event is the malware-derived event. When receiving the notification from the event recognition unit, the content comprehension unit acquires an analysis screen corresponding to the notification from the execution history table, acquires malware information related to the acquired analysis screen, and stores the acquired malware information in the execution history table. The procedure extraction unit acquires the malware information from the execution history table, acquires an operation procedure related to the acquired malware information, and stores the acquired operation procedure in the execution history table. The code generation unit acquires the operation procedure from the execution history table, references the code table to transform the acquired operation procedure to a code corresponding to the operation procedure, and applies the code resulting from the transformation to a template to generate an automation program for malware analysis.

Another aspect of the present invention is a malware analysis method using: a screen acquisition unit, an event recognition unit, a content comprehension unit, a procedure extraction unit, and a code generation unit that are implemented by a CPU; and an execution history table and a code table that are held by a storage unit. The code table holds a code required for malware execution and corresponding to a behavior pattern and a variable. When acquiring an analysis screen to be analyzed, the screen acquisition unit stores the acquired analysis screen and an acquisition time thereof in the execution history table. The event recognition unit references the execution history table to acquire information indicating whether or not an event corresponding to the analysis screen stored by the screen acquisition unit is a malware-derived event, and notifies the content comprehension unit when the event is the malware-derived event. When receiving the notification from the event recognition unit, the content comprehension unit acquires an analysis screen corresponding to the notification from the execution history table, acquires malware information related to the acquired analysis screen, and stores the acquired malware information in the execution history table. The procedure extraction unit acquires the malware information from the execution history table, acquires an operation procedure related to the acquired malware information, and stores the acquired operation procedure in the execution history table. The code generation unit acquires the operation procedure from the execution history table, references the code table to transform the acquired operation procedure to a code corresponding to the operation procedure, and applies the code resulting from the transformation to a template to generate an automation program for malware analysis.

According to the present invention, it is possible to generate an automation program that precisely acquires requested reactions for a wide variety of malware events, and provides appropriate reactions. Objects, configurations, and effects other than the above will be apparent from the description of the following embodiments.

### BRIEF DESCRIPTION OF THE DRAWINGS

FIG. 1 is a block diagram illustrating an example of a configuration of a malware analysis system.

FIG. 2 is a table diagram illustrating an example of a data structure of an execution history table.

FIG. 3 is a table diagram illustrating an example of a data structure of a prompt table.

FIG. 4 is a table diagram illustrating an example of a data structure of a code table.

FIG. 5 is a table diagram illustrating an example of a data structure of an icon table.

FIG. 6 is a flow chart illustrating an outline of processing performed by an automatic analysis system.

FIG. 7 is a flow chart illustrating an example of screen acquisition processing performed by the automatic analysis system.

FIG. 8 is a flow chart illustrating an example of event recognition processing performed by the automatic analysis system.

FIG. 9 is a flow chart illustrating an example of content comprehension processing performed by the automatic analysis system.

FIG. 10 is a flow chart illustrating an example of procedure extraction processing performed by the automatic analysis system.

FIG. 11 is a flow chart illustrating an example of code generation processing performed by the automatic analysis system.

FIG. 12 is a flow chart illustrating an example of coordinate acquisition processing performed by the automatic analysis system.

### DETAILED DESCRIPTION OF THE PREFERRED EMBODIMENTS

Hereinbelow, embodiments of the present invention will be described with reference to the drawings. Note that the following description and the drawings are examples for describing the present invention, and are appropriately omitted or simplified for clarity of the description. The present invention can also be implemented in various other forms. Unless particularly limited, each component may be either singular or plural.

In the following description, it may be possible that the same or similar components are denoted by the same reference signs, and a repetitive description thereof is omitted. In addition, in the following description, various information may be described by using such terms as “information” and “table”, but the various information may also be represented by using data structures other than these.

The positions, sizes, shapes, ranges, and the like of individual components illustrated in the drawings or the like may not represent actual positions, sizes, shapes, ranges, and the like to facilitate understanding of the present invention. Accordingly, the present invention is not limited to the positions, sizes, shapes, ranges, and the like disclosed in the drawings or the like.

One of the embodiments described below in detail is a malware analysis system including a screen acquisition unit, an event recognition unit, a content comprehension unit, a procedure extraction unit, and a code generation unit that are implemented by a CPU, and an execution history table and a code table that are held by a storage unit, in which the code table holds a code required for malware execution and corresponding to a behavior pattern and a variable, and, when acquiring an analysis screen to be analyzed, the screen acquisition unit stores the acquired analysis screen and an acquisition time thereof in the execution history table, in which the event recognition unit references the execution history table to determine whether or not an event corresponding to the analysis screen stored by the screen acquisition unit is a malware-derived event, and notifies the content comprehension unit when the event is the malware-derived event, and, when receiving the notification from the event recognition unit, the content comprehension unit acquires an analysis screen corresponding to the notification from the execution history table, generates malware information related to the acquired analysis screen, and stores the generated malware information in the execution history table, in which the procedure extraction unit acquires the malware information from the execution history table, generates an operation procedure related to the acquired malware information, and stores the generated operation procedure in the execution history table, and in which the code generation unit acquires the operation procedure from the execution history table, references the code table to transform the acquired operation procedure to a code corresponding to the operation procedure, and applies the code resulting from the transformation to a template to generate an automation program for malware analysis.

### First Embodiment

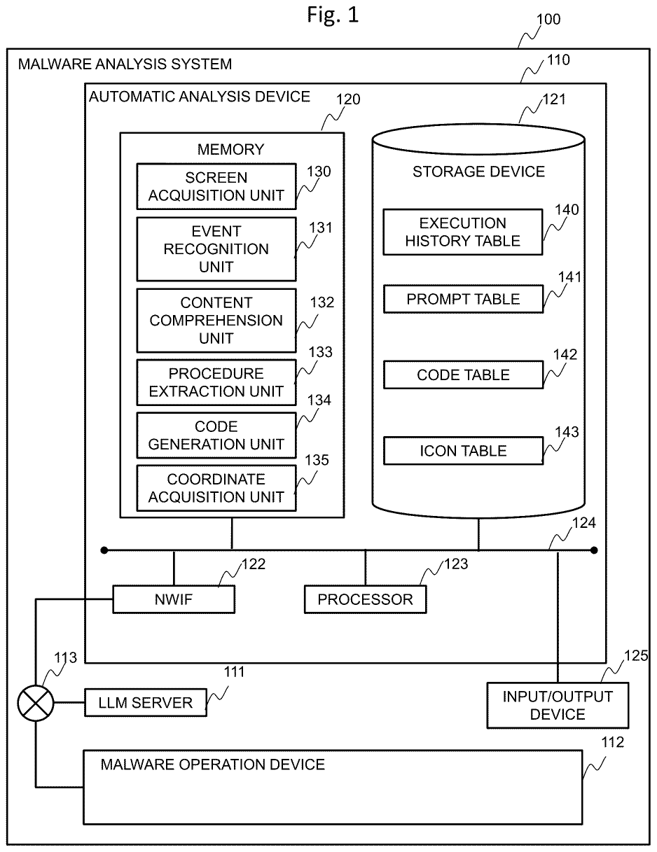

FIG. 1 is a diagram illustrating an example of a configuration of a malware analysis system. A malware analysis system 100 is configured to include an automatic analysis device 110, an LLM (Large Language Model) server 111, and a malware operation device 112.

The automatic analysis device 110 is connected to the LLM server 111 and the malware operation device 112 via a network 113.

A specific example of the LLM server 111 is a large-scale language model LLM such as the Chat-GPT (trademark), and the LLM server 111 analyzes a natural language and an image. In addition to an interactive generative AI (artificial intelligence) as described above, an inference unit that outputs a result of analyzing a predetermined input is applicable. For example, the LLM server 111 is an AI constructed by machine learning.

The network 113 is, e.g., a LAN (Local Area Network). Note that the present embodiment is not limited to the type of the network 113. In addition, a connection method of the network 113 may be either wired or wireless.

Each of the automatic analysis device 110 and the malware operation device 112 is, e.g., a personal computer, a smartphone, a tablet, or the like. The malware operation device 112 has a processor, a memory, a storage device, and a network interface which are not shown. Note that, for the malware operation device 112, software and an application which are related to malware execution may also be installed in advance. The malware operation device 112 causes malware to operate in a safe environment to acquire information required for analysis of the malware.

The automatic analysis device 110 monitors behavior of the malware executed in the malware operation device 112, and automatically performs an appropriate operation. The automatic analysis device 110 is configured to include at least one calculator. It is assumed that, in the first embodiment, the automatic analysis device 110 is implemented by using the one calculator. The automatic analysis device 110 includes, as hardware items, a memory 120, a storage device 121, a network interface 122, and a processor 123. The individual hardware items are connected to each other via a communication path 124, which is an information transmission medium for information transmission or the like, such as a bus or a cable.

Note that the automatic analysis device 110 may also be connected to an input/output device 125 for performing input/output operations on the automatic analysis device, such as a keyboard, a mouse, a touch panel, a display, or a printer.

The memory 120 is a RAM (Random Access Memory) or the like, has a volatile storage element, and stores a program to be executed by the processor 123 and data. The memory 120 is used also as a work area, which is temporarily used by the program.

The storage device 121 is a HDD (Hard Disk Drive), an SSD (Solid State Drive), or the like, has a nonvolatile storage element, and permanently stores a large amount of data.

The processor 123 is a CPU (Central Processing Unit) or the like, and executes the program stored in the memory 120. By performing processing according to the program, the processor 123 operates as a module (functional unit) that implements a specific function. In the following description, when a description will be given of processing by using the functional unit as a subject, it is indicated that the processor 123 is executing the processing.

A description will be given herein of the functional unit to be stored in the memory 120 and information to be stored in the storage device 121 in the first embodiment.

The memory 120 stores therein a screen acquisition unit 130, an event recognition unit 131, a content comprehension unit 132, a procedure extraction unit 133, a code generation unit 134, and a coordinate acquisition unit 135.

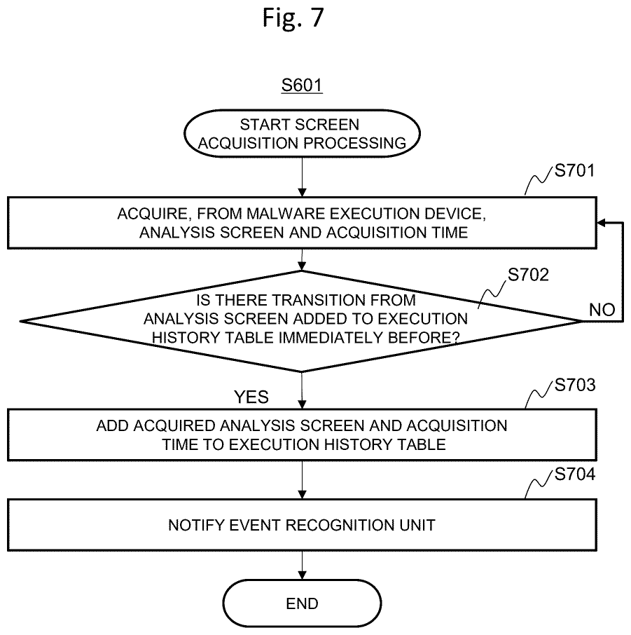

The screen acquisition unit 130 performs the screen acquisition processing (see FIG. 7). In the screen acquisition processing, the screen acquisition unit 130 acquires a screen displayed on the malware operation device 112 while executing the malware.

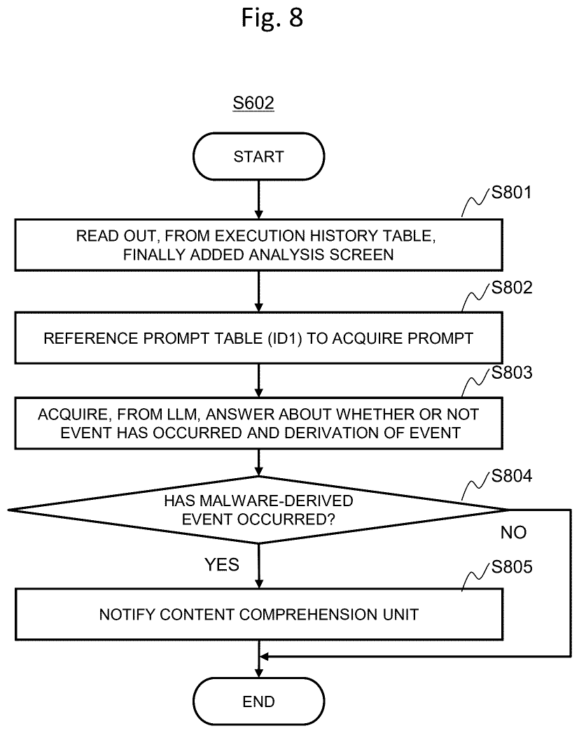

The event recognition unit 131 performs the event recognition processing (see FIG. 8). In the event recognition processing, the event recognition unit 131 recognizes or detects, from the screen displayed on the malware operation device 112, a GUI (Graphical User Interface) that requests a reaction from a user, which is displayed by the malware. In the following description, the GUI that requests the reaction from the user, which is displayed on the malware, is referred to simply as the event.

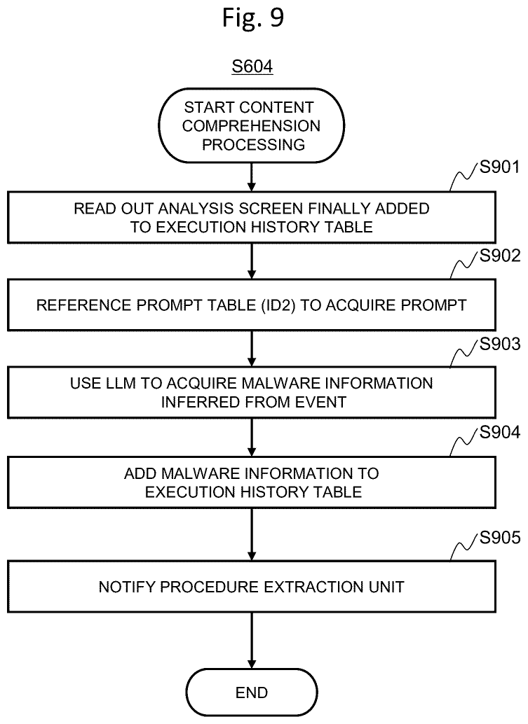

The content comprehension unit 132 performs content comprehension processing (see FIG. 9) of acquiring malware information inferred from the event. The malware information includes information related to the malware, which is inferred from an event, such as a family name, an operation related to malware execution, or the basis for inference.

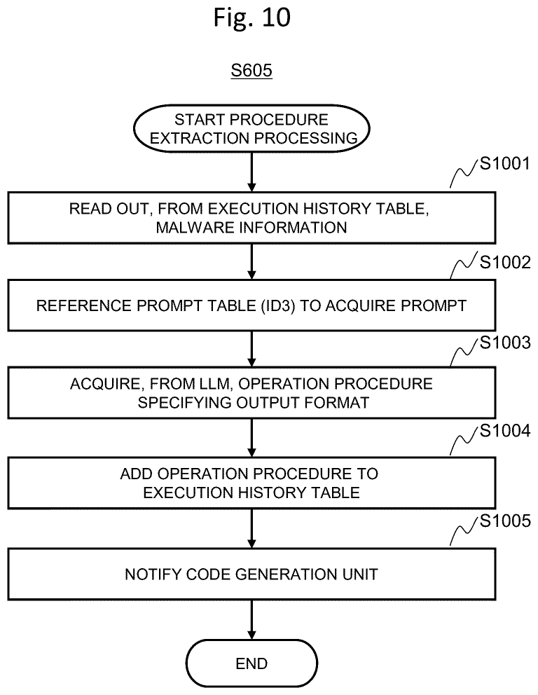

The procedure extraction unit 133 performs the procedure extraction processing (see FIG. 10). In the procedure extraction processing, the procedure extraction unit 133 extracts, from the malware information, only an operation procedure related to the malware execution. In the following description, the operation procedure related to the malware execution is referred to simply as the operation procedure.

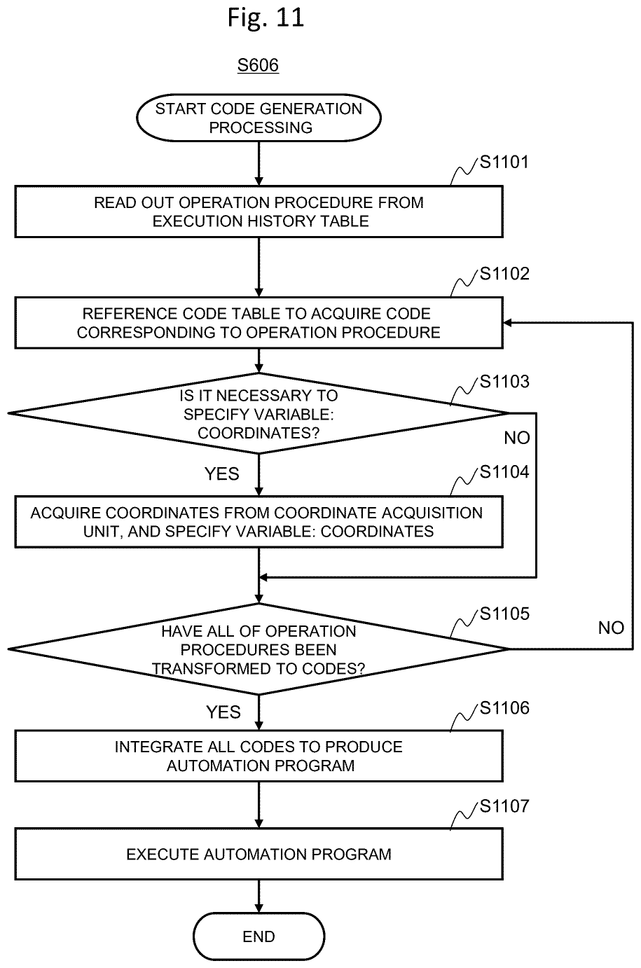

The code generation unit 134 performs the code generation processing (see FIG. 11). In the code generation processing, the code generation unit 134 generates a code for producing an automation program from the operation procedure.

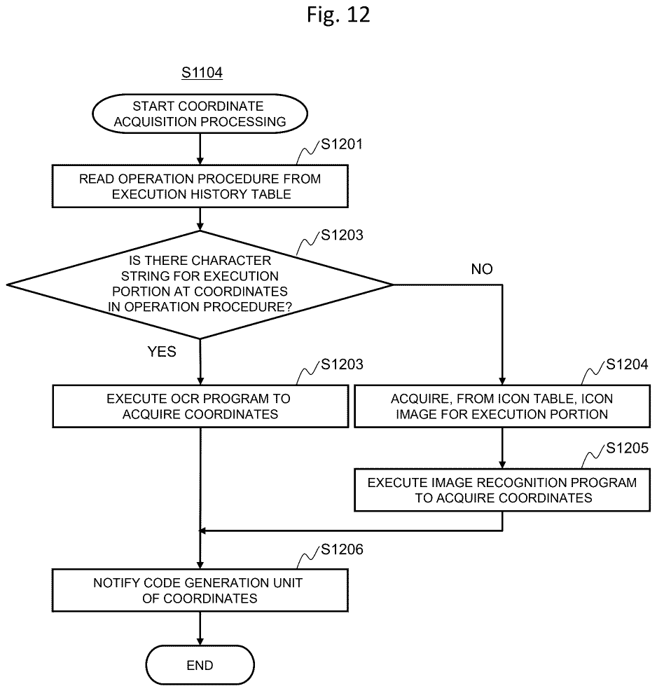

The coordinate acquisition unit 135 performs the coordinate acquisition processing (see FIG. 12). In the coordinate acquisition processing, the coordinate acquisition unit 135 acquires coordinates related to an operation.

Note that, in the memory 120, the functional unit that controls the entire automatic analysis device 110, not shown, may also be stored.

The storage device 121 stores therein an execution history table 140, a prompt table 141, a code table 142, and an icon table 143.

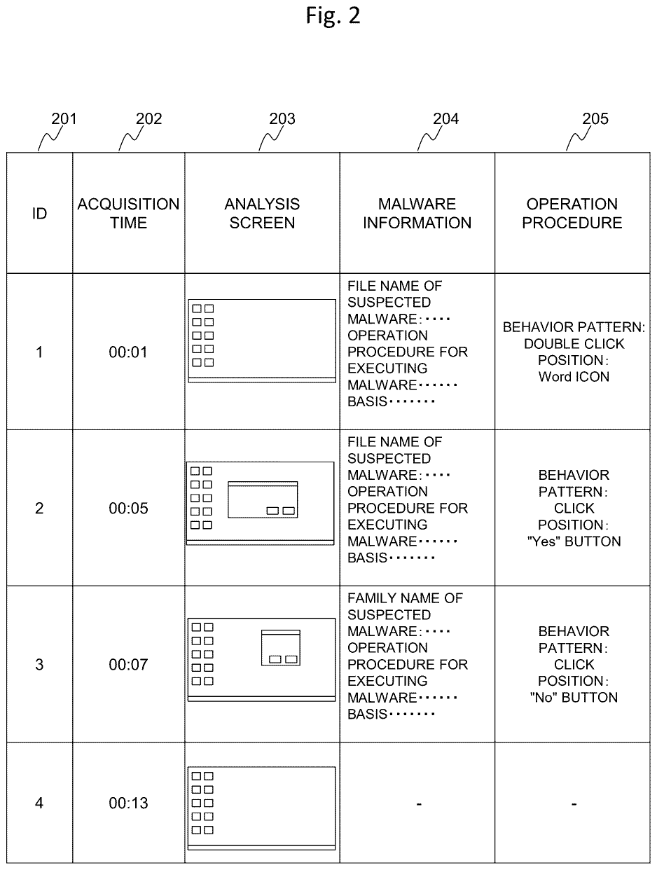

The execution history table 140 is for managing a result of malware analysis. A data structure in the execution history table 140 will be described with reference to FIG. 2.

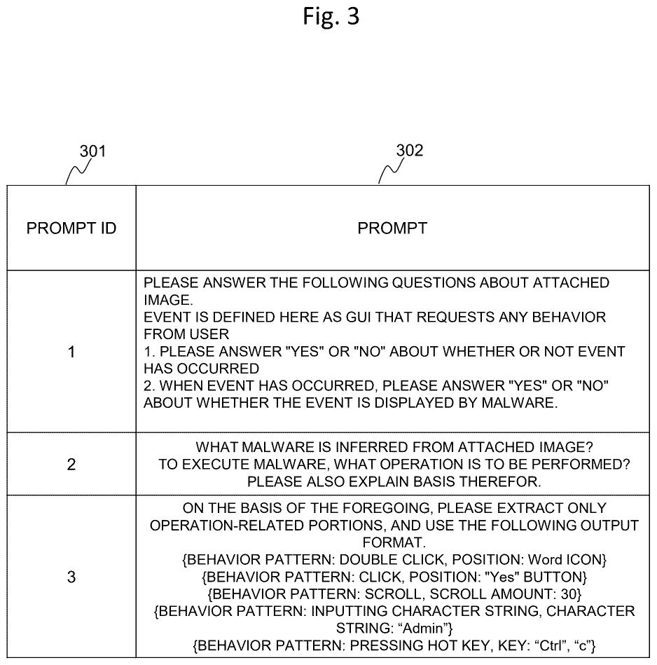

The prompt table 141 is for managing prompts to be input to the LLM server 111. A data structure in the prompt table 141 will be described with reference to FIG. 3.

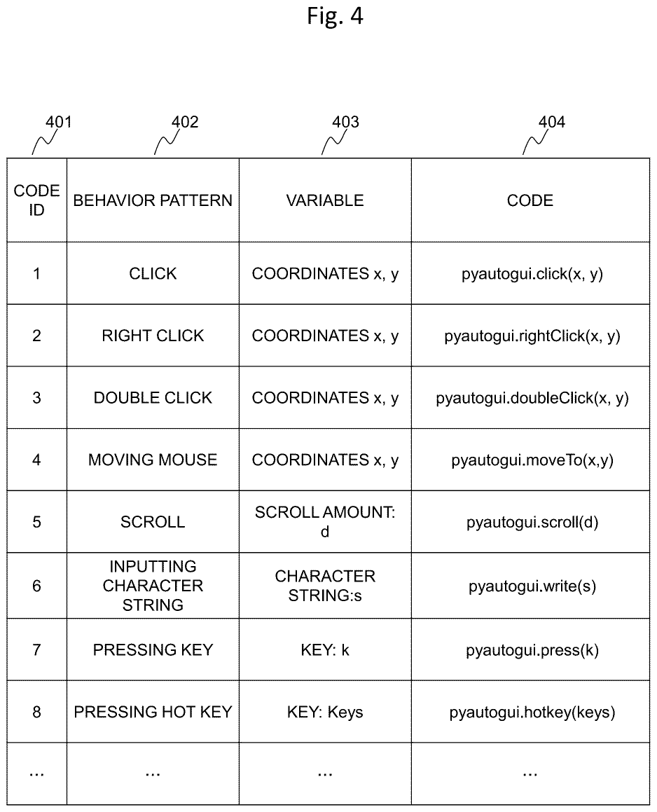

The code table 142 is for managing codes required for an automatic operation. A data structure in the code table 142 will be described with reference to FIG. 4.

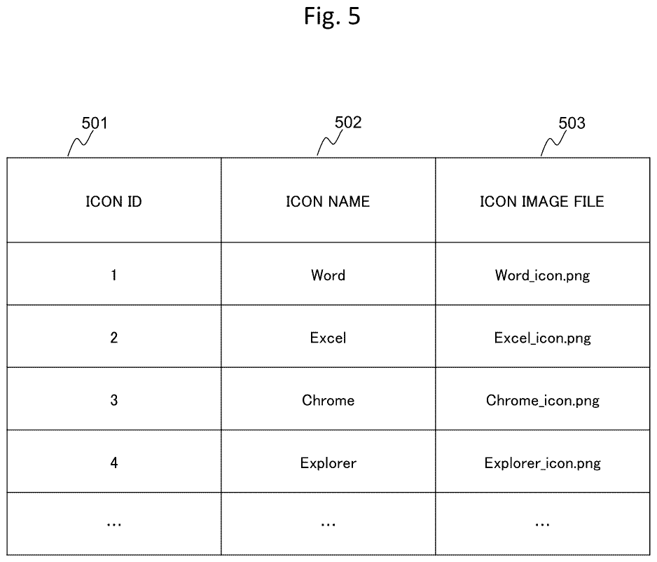

The icon table 143 is for managing icon images required to acquire coordinates related to an operation. A data structure in the icon table 143 will be described with reference to FIG. 5.

The configuration of the malware analysis system 100 in FIG. 1 is exemplary, and the automatic analysis device 110, the LLM server 111, and the malware operation device 112 may be physically separate information processing devices connected via a network, may also be scattered on a cloud, or may also be a single information processing device which is virtually separated.

FIG. 2 is a diagram illustrating an example of a data structure of the execution history table 140 in the first embodiment. The execution history table 140 stores therein an entry configured to include an ID 201, an acquisition time 202, an analysis screen 203, malware information 204, and an operation procedure 205. Note that a structure of the entry is an example, and is not limited thereto. The entry need not include any of the fields mentioned above, or may also include another field.

The ID 201 is the field for storing identification information for uniquely identifying the analysis screen 203 in chronological order. The ID 201 in the first embodiment stores therein a number as the identification information.

The acquisition time 202 is the field for storing the time elapsed from the start of the malware execution to the acquisition of the analysis screen. The acquisition time 202 may be either an absolute time or a relative time. For example, the acquisition time 202 having the ID of “1” in the first embodiment indicates that the analysis screen was acquired 1 second after the time when the malware execution was started. The present embodiment is not limited to a data format of the time stored in the acquisition time 202. Any data format that allows a time to be determined, such as Unixtime, may also be used.

The analysis screen 203 is the field for storing, as an image file, a screen displayed on the malware operation device 112. On the analysis screen 203, the screen that is acquired by the screen acquisition unit 130 by executing the screen acquisition processing and is displayed on the malware operation device 112 while executing the acquired malware is stored. The screen acquisition unit 130 acquires a new analysis screen every time, e.g., the screen transitions.

The present embodiment is not limited to the data format of an image file stored on the analysis screen 203. Any data format that allows a screen displayed in an analysis environment to be visually determined, such as JPEG, may also be used.

The malware information 204 is the field for storing information on malware inferred from the event. The malware information 204 stores therein the malware information inferred by the content comprehension unit 132 from the event recognized/detected by the event recognition unit 131.

The malware information 204 in the first embodiment stores therein the family name of suspected malware, an operation procedure for executing the malware, and the basis for inference. Note that the information included in the malware information 204 is an example, and is not limited thereto.

The operation procedure 205 is the field for storing information on the operation procedure related to the malware execution. In the operation procedure 205, the operation procedure extracted by the procedure extraction unit 133 from the malware information 204 is stored. The operation procedure 205 is configured to include a behavior pattern in mouse and keyboard operations and a variable corresponding to the behavior pattern. For example, the operation procedure having the ID of “2” in the first embodiment indicates an operation procedure of clicking a “Yes” button (position on a screen where the “Yes” button is displayed).

FIG. 3 is a diagram illustrating an example of a data structure of the prompt table 141 in the first embodiment.

The prompt table 141 stores therein an entry configured to include a prompt ID 301 and a prompt 302. Note that a structure of the entry is an example, and is not limited thereto. The entry need not include any of the fields mentioned above, or may also include another field.

The prompt ID 301 is the field for storing identification information for uniquely identifying a prompt. The prompt ID 301 in the first embodiment stores therein a number as the identification information.

The prompt 302 is the field for storing the prompt input to the LLM server 111. For example, the prompt 302 having the prompt ID 301 of “2” in the first embodiment indicates a prompt for acquiring the malware information 204. Note that the information included in the prompt 302 is an example, and is not limited thereto.

In the present embodiment, the event recognition unit 131, the content comprehension unit 132, and the procedure extraction unit 133 assume the use of an interactive generative AI of the LLM server 111, and therefore give an instruction by using a prompt (directive). However, depending on the type of the AI, it may also be possible to give an instruction by using a code via, e.g., an API (Application Programming Interface) without using the prompt.

FIG. 4 is a diagram illustrating an example of a data structure of the code table 142 in the first embodiment. The code table 142 manages the correspondence between the behavior pattern, the variable included in the behavior pattern, and a code, which is referenced upon transformation to the code based on the behavior pattern.

The code table 142 stores therein an entry configured to include a code ID 401, a behavior pattern 402, a variable 403 and a code 404. Note that a structure of the entry is an example, and is not limited thereto. The entry need not include any of the fields mentioned above, or may also include another field.

The code ID 401 is the field for storing identification information for uniquely identifying the behavior pattern 402. The code ID 401 in the first embodiment stores therein a number as the identification information.

The behavior pattern 402 is the field for storing information on mouse and keyboard operation names. For example, the behavior pattern 402 in the first embodiment stores therein operation names such as a click, a right click, and a double click. Note that the information included in the behavior pattern 402 is an example, and is not limited thereto.

The variable 403 is the field for storing information related to a variable specific to the behavior pattern 402. For example, the variable 403 in the behavior pattern 402 of “click” in the first embodiment is coordinates including two variables x and y. Other examples of the variable 403 include a scrolling degree, an input character string, a pressed key, and the like, but the variable 403 is not limited thereto.

The code 404 is the field for storing information related to a code corresponding to the behavior pattern 402. The code has information on the variable to be stored in the variable 403 in the same entry. For example, the code 404 in the first embodiment indicates a source code in a PyAuto GUI library.

Note that the information included in the code 404 is an example, and is not limited thereto. Any code, such as a source code, a binary code, or the like in another library, may be used as long as the code is for automating the behavior pattern 402.

FIG. 5 is a diagram illustrating an example of a data structure of the icon table 143 in the first embodiment. The icon table 143 stores therein an entry configured to include an icon ID 501, an icon name 502, and an icon image file 503. Note that a structure of the entry is an example, and is not limited thereto. The entry need not include any of the fields mentioned above, or may also include another field.

The icon ID 501 is the field for storing identification information for uniquely identifying the icon name 502. The icon ID 501 in the first embodiment stores therein a number as the identification information.

The icon name 502 is the field for storing information on the icon name related to coordinate acquisition. For example, the icon name 502 stores therein information on names of software and applications each related to malware execution, which have been installed in advance in the malware operation device 112. In FIG. 5, Word (trademark), Excel (trademark), Chrome (trademark), and Explorer (trademark) are shown by way of example.

Note that the information included in the icon name 502 is an example, and is not limited thereto. Any icon name may also be used as long as the icon name is information that can be acquired in advance as an image.

The icon image file 503 is the field for storing an image file corresponding to the icon name 502.

Next, a description will be given of processing to be performed by the automatic analysis device 110. It is assumed that, before the processing by the automatic analysis device 110 is executed, the malware operation device 112 is caused to execute the malware to be analyzed. In the present embodiment, the malware execution is not limited to a malware execution method.

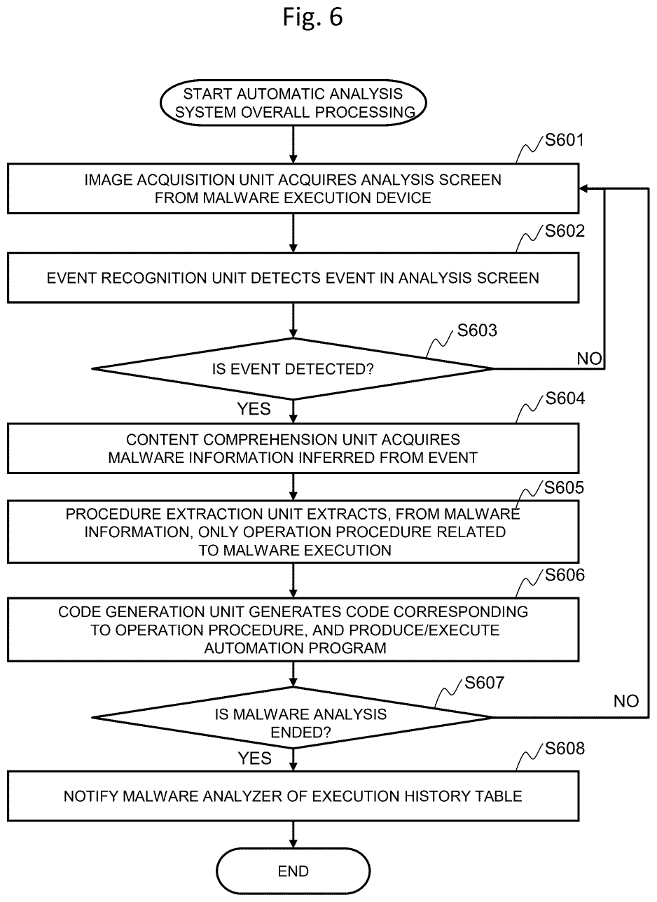

FIG. 6 is a flow chart illustrating the overview of the processing to be performed by the automatic analysis device 110 in the first embodiment.

The automatic analysis device 110 periodically executes the processing described below.

The automatic analysis device 110 uses the screen acquisition unit 130 to acquire the analysis screen to be displayed on the malware operation device 112 (Step S601).

The automatic analysis device 110 uses the event recognition unit 131 to detect an event in the analysis screen (Step S602).

Then, in Step S602, the automatic analysis device 110 determines whether or not an event is detected (Step S603).

When no event is detected, the automatic analysis device 110 returns to Step S601 to execute the same processing.

When an event is detected, the automatic analysis device 110 advances to Step S604.

The automatic analysis device 110 uses the content comprehension unit 132 to acquire the malware information inferred from the analysis screen including the event (Step S604). The malware information includes the family name of suspected malware, an operation procedure for executing the malware, and the basis for inference.

The automatic analysis device 110 uses the procedure extraction unit 133 to extract only the operation procedure related to the malware execution from the malware information acquired in Step S604 (Step S605).

The automatic analysis device 110 uses the code generation unit 134 to generate a code corresponding to the operation procedure extracted in Step S605, produce the automation program, and execute the automation program (Step S606).

Next, the automatic analysis device 110 determines whether or not the malware analysis is ended in the malware operation device 112 (Step S607). In the present embodiment, the determination of the end of the analysis is not limited to an analysis end determination method.

When the malware analysis is not ended, the automatic analysis device 110 returns to Step S601 to execute the same processing.

When the malware analysis is ended, the automatic analysis device 110 advances to Step S608.

The automatic analysis device 110 notifies a malware analyzer of the execution history table 140 (Step S608). The acquisition time 202, the analysis screen 203, the malware information 204, and the operation procedure 205 which are stored in the execution history table 140 are information which is useful when the analyzer manually analyzes details.

FIG. 7 is a flow chart illustrating an example of screen acquisition processing (Step S601) to be executed by the automatic analysis device 110 in the first embodiment.

When receiving an execution instruction, the screen acquisition unit 130 implemented by the processor 123 starts the image acquisition processing described below.

The screen acquisition unit 130 acquires an analysis screen on which the behavior of the malware (or a malware candidate, the same applies hereinafter) currently executed by the malware operation device 112 is displayed. At the same time, the screen acquisition unit 130 acquires, as the acquisition time, a differential time between the time when the analysis screen was acquired and the time when the malware execution was started (Step S701).

Then, the screen acquisition unit 130 focuses attention on the difference of the analysis screen acquired in Step S701 from the analysis screen added to the execution history table 140 immediately before, and determines whether or not a screen transition has been made (Step S702).

When the screen transition has been made or when no analysis screen has been added to the execution history table 140, the screen acquisition unit 130 advances to Step S703.

When no screen transition has been made, the screen acquisition unit 130 returns to Step S701 to execute the same processing.

Next, the screen acquisition unit 130 adds the analysis screen and the acquisition time each acquired in Step S701 to the execution history table 140 (Step S703).

Specifically, when a screen transition is made from the analysis screen stored in the analysis screen 203 in the entry having the ID 201 of “1”, the screen acquisition unit 130 adds the analysis screen and the acquisition time each acquired in Step S701 to the acquisition time 202 and the analysis screen 203 in the entry having the ID 201 of “2”.

Then, the screen acquisition unit 130 notifies the event recognition unit 131 that the execution history table 140 has been updated (Step S704).

FIG. 8 is a flow chart illustrating an example of the event recognition processing (Step S602) to be executed by the automatic analysis device 110 in the first embodiment.

When receiving an execution instruction, the event recognition unit 131 implemented by the processor 123 starts the event recognition processing described below.

The event recognition unit 131 reads out the analysis screen finally added to the execution history table 140 (Step S801).

Then, the event recognition unit 131 acquires a prompt from the prompt 302 in the same entry as that of the prompt ID 301 of “1” in the prompt table 141 (Step S802). In the prompt 302 in the same entry as that of the prompt ID 301 of “1” in the prompt table, a prompt for detecting an event is entered in advance.

Specifically, a prompt is configured to include a phrase that causes the definition of an event, whether or not the event has occurred, and derivation of the event to be output and the like. Note that the details of the prompt are an example, and are not limited thereto. It is only needed that information about whether or not the event has occurred and the derivation of the event is output.

Then, the event recognition unit 131 inputs the analysis screen read out in Step S801 and the prompt acquired in Step S802 to the LLM server 111 to cause the LLM server 111 to output whether or not a malware-derived event has occurred. (Step S803).

Then, the event recognition unit 131 detects whether or not the malware-derived event has occurred (Step S804).

When the malware-derived event has not occurred, the event recognition unit 131 ends the event recognition processing.

When the malware-derived event has occurred, the event recognition unit 131 advances to Step S805.

Next, the event recognition unit 131 notifies the content comprehension unit 132 that the malware-derived event has occurred (Step S805).

FIG. 9 is a flow chart illustrating an example of the content comprehension processing (Step S604) to be executed by the automatic analysis device 110 in the first embodiment.

When receiving an execution instruction, the content comprehension unit 132 implemented by the processor 123 starts the content comprehension processing described below.

The content comprehension unit 132 reads out the analysis screen added finally to the execution history table 140 (Step S901).

Then, the content comprehension unit 132 acquires a prompt from the prompt 302 in the same entry as that of the prompt ID 301 of “2” in the prompt table 141 (Step S902). In the prompt 302 in the same entry as that of the prompt ID 301 of “2” in the prompt table, a prompt for acquiring malware information is entered in advance.

Specifically, a prompt is configured to include information on malware inferred from an event, information on a procedure of inducing malware execution, a phrase that causes the ground for inference to be output, and the like. Note that the details of the prompt are an example, and are not limited thereto. It is only needed that information about whether or not the event has occurred and the derivation of the event is output.

Then, the content comprehension unit 132 inputs the analysis screen read out in Step S901 and the prompt acquired in Step S902 to the LLM server 111, and causes the LLM server 111 to output malware information (Step S903).

Then, the content comprehension unit 132 adds the malware information acquired in Step S903 to the execution history table 140 (Step S904).

Specifically, in the execution history table 140, the content comprehension unit 132 adds the malware information acquired in Step S903 to the malware information 204 in the same entry as that in which the analysis screen acquired in Step S901 is stored.

Then, the content comprehension unit 132 notifies the procedure extraction unit 133 that the execution history table 140 has been updated (Step S905).

FIG. 10 is a flow chart illustrating an example of the procedure extraction processing (Step S605) to be executed by the automatic analysis device 110 in the first embodiment.

When receiving an execution instruction, the procedure extraction unit 133 implemented by the processor 123 starts the procedure extraction processing described below.

The procedure extraction unit 133 reads out the malware information from the execution history table 140 (Step S1001).

Then, the procedure extraction unit 133 acquires a prompt from the prompt 302 in the same entry as that of the prompt ID 301 of “3” in the prompt table 141 (Step S1002). In the prompt 302 in the same entry as that of the prompt ID 301 of “3” in the prompt table, a prompt for extracting an operation procedure is entered in advance.

The prompt is produced in advance based on the assumption that the code generation unit 134 references the code table 142 to acquire a source code corresponding to the operation procedure. Specifically, an inventive approach is taken such as giving, as an example of an answer, various behavior patterns and variables corresponding to the behavior patterns, such as {BEHAVIOR PATTERN: INPUTTING CHARACTER STRING, VARIABLE: “Admin”} (such a method of causing several examples to be included in the prompt is known as a method referred to generally as Few-Shot Prompting).

Note that the details of the prompt are an example, and are not limited thereto. It is only needed to output information on the behavior patterns and variables in a format that allows the code table 142 to be referenced.

Then, the procedure extraction unit 133 inputs, to the LLM server 111, the malware information read out in Step S1001 and the prompt acquired in Step S1002, and causes the LLM server 111 to output the operation procedure (Step S1003). The operation procedure is configured to include the behavior pattern and the variable corresponding to the behavior pattern according to an example of the given answer. Note that the single operation procedure or the plurality of the operation procedures are output.

Then, the content comprehension unit 132 adds the operation procedure acquired in Step S1003 to the execution history table 140 (Step S1004).

Specifically, the procedure extraction unit 133 adds the operation procedure acquired in Step S1003 to the operation procedure 205 in the same entry as that in which the analysis screen acquired in Step S1001 is stored.

Then, it notifies the code generation unit that the execution history table 140 has been updated (Step S1005).

FIG. 11 is a flow chart illustrating an example of the code generation processing (Step S606) to be executed by the automatic analysis device 110 in the first embodiment.

When receiving an execution instruction, the code generation unit 134 implemented by the processor 123 starts the code generation processing described below.

The code generation unit 134 reads out the operation procedure from the execution history table 140 (Step S1101).

Then, code generation unit 134 references the operation procedure 205 in the code table 142 on the basis of the operation procedure read out in Step S1101, and acquires the code corresponding to the operation procedure (Step S1102).

For example, when the operation procedure {BEHAVIOR PATTERN: INPUTTING CHARACTER STRING, VARIABLE: “Admin”} is to be transformed to a code, the code generation unit 134 references {BEHAVIOR PATTERN: INPUTTING CHARACTER STRING}, and acquires the code pyautogui. write (s) from the code table 142. Since VARIABLE: “Admin” is included in the operation procedure, the code generation unit 134 also acquires a code specifying the variable, such as s=“Admin”.

There is a case where the operation procedure acquired by the procedure extraction unit 133 from the LLM server 111 includes no variable. For example, with regard to a case where the operation procedure includes a position to which the behavior pattern is to be applied, such as in the ID 201 of each of “1”, “2”, and “3” in the execution history table 140 in FIG. 2, the coordinate acquisition unit 135 separately acquires the variable.

Note that the information included in the acquired code is an example, and is not limited thereto. Any code, such as a source code, a binary code, or the like in another library, may be used as long as the code is for automating the behavior pattern.

Then, the code generation unit 134 determines whether or not the code acquired in Step S1102 requires coordinates as the variable (Step S1103).

When the coordinates are not required as the variable, the code generation unit 134 advances to Step S1105.

When the coordinates are required as the variable, the code generation unit 134 advances to Step S1104.

Then, the code generation unit 134 notifies the coordinate acquisition unit 135, and acquires coordinates at a portion where the operation is to be performed (Step S1104). Specifically, the code generation unit 134 acquires the code for specifying the coordinates, e.g., x=1200, y=800 from the coordinate acquisition unit 135. The coordinate acquisition processing will be described with reference to FIG. 12.

Next, the code generation unit 134 determines whether or not all of the operation procedures read out in Step S1101 have been completely transformed (Step S1105).

When all of the operation procedures have not been completed transformed to the codes, the code generation unit 134 returns to Step S1102 to execute the same processing.

When all of the operation procedures have been completed transformed to the codes, the code generation unit 134 advances to Step S1106.

Then, the code generation unit 134 produces the automation program on the basis of all the acquired codes and a template produced in advance (Step S1106). For example, when the automation program is to be produced in a PyAuto GUI, a code required for the execution, such as a code for importing a library, such as “import pyautogui”, is produced in advance as the template.

The automation program is produced by integrating the code acquired in Step S1102 with the template. A simple example of the automation program is shown below.
import pyautogui
x=1200
y=800
pyautogui.clic (x, y)

Then, the code generation unit 134 executes the automation program produced in Step S1106 to perform an automatic operation on the event displayed on the malware operation device 112 (Step S1107).

In the present embodiment, by referencing the code table 142 in which the operation procedure and the code corresponding to the operation are specified in advance, the code is generated. Thus, the automation program that can be executed is allowed to be generated from the operation procedure in a natural language output from the LLM server 111.

In addition, by generating the code on the basis of the code table 142 prepared in advance, not by causing the LLM server 111 to directly output the automation program, it is possible to exclude the code leading to the execution of an unintended operation and safely generate the automation program.

FIG. 12 is a flow chart illustrating an example of the coordinate acquisition processing (Step 1104) to be executed by the automatic analysis device 110 in the first embodiment. There is an operation procedure that specifies an icon or a button to be clicked or double-clicked but, to implement transformation to a code and correct automatic execution thereof, coordinates of the icon or the button are required.

When receiving an execution instruction, the coordinate acquisition unit 135 implemented by the processor 123 starts the coordinate acquisition processing described below.

The coordinate acquisition unit 135 reads out the operation procedure from the execution history table 140 (Step S1201).

Then, the coordinate acquisition unit 135 determines whether or not there is a character string for the execution portion at the position in the operation procedure (Step S1202). For example, it is determined that, in the operation procedure {BEHAVIOR PATTERN: CLICK, POSITION: “Yes” Button}, the character string (“Yes”) for the execution portion is present. It is determined that, in the operation procedure {BEHAVIOR PATTERN: CLICK, POSITION: Word ICON}, the character string for the execution portion is absent.

When there is the character string at the position, the coordinate acquisition unit 135 advances to Step S1203.

When there is not the character string at the position, the coordinate acquisition unit 135 advances to Step S1204.

Then, the coordinate acquisition unit 135 executes an OCR (Optical Character Recognition) program on the basis of the character string present at the position to acquire the coordinates (Step S1203). The acquired coordinates are acquired in a form that can be integrated with the automation program, such as x=1200, y=800. Note that, when the coordinates are output in a format that is not integrated with the automation program, processing of changing the format may also be added. After the acquisition of the coordinates, the coordinate acquisition unit 135 advances to Step S1206. In addition to the OCR, any type of program that can recognize and extract the character string may be used.

Then, the coordinate acquisition unit 135 references the icon table 143 to acquire an icon image for the execution portion (Step S1204). For example, in the operation procedure {BEHAVIOR PATTERN: CLICK, POSITION: Word ICON}, the coordinate acquisition unit 135 references the icon table 143 on the basis of the icon name “Word” included in the position to acquire, from the icon image file 503 in the same entry as that of the icon name 502 of “Word”, a “Word” icon image.

Then, the coordinate acquisition unit 135 executes an image recognition program on the basis of the icon image acquired in Step S1204 to acquire the coordinates (Step S1205). The coordinates acquired according to the image recognition program are output, similarly to the coordinates acquired according to the OCR program.

Then, the coordinate acquisition unit 135 notifies the code generation unit 134 of the coordinates acquired in Step S1203 or Step S1205 (Step S1206).

As described above, the first embodiment has the following features.
(1) The automatic analysis device 110 precisely acquires the reaction required by the malware-derived event in the malware operation device 112, and automatically operate an appropriate reaction. As a result, the number of malware items that can be automatically analyzed increases, and it is possible to improve coverage of information to be referenced when it is determined whether or not manual analysis by an analyzer is further required.
(2) The code generation unit 134 references the code table 142 produced in advance to generate the code corresponding to the operation procedure. As a result, it is possible to enable easy generation of the code required for the automation program from the operation procedure in a natural language output from the LLM server 111. In addition, the code 404 held in the code table 142 was produced by the user, and is extremely low in the possibility that an unintended operation is performed, which secures safety.
(3) The execution history table 140 has the acquisition time 202, the analysis screen 203, the malware information 204, and the operation procedure 205 to be acquired by the individual functional units. These information items are information which is useful when the analyzer manually analyzes details.

For example, chronological transition of the analysis screen 203 and the operation procedure 205 required for the transition can be recognized. When the analyzer performs manual analysis, by performing an operation exactly according to the analysis screen 203 and the operation procedure 205 that are stored in the execution history table 140, the analysis can be carried out efficiently.

### Second Embodiment

In Step S1106 in FIG. 11, by automatically operating malware in the malware operation device 112, it is possible to safely and stably operate the malware without involving a manual operation by the analyzer. By automatically executing the malware in a virtual environment, observing the behavior thereof, and recording the behavior (dynamic analysis), network communication and a file operation are recorded, states of file production and a registry change are monitored, and details of the network communication are analyzed to allow data required for the automatic analysis of the malware to be collected and analyzed. By thus automatically acquiring history data of the operation of the malware without human intervention, it is possible to automatically analyze the malware.

### Third Embodiment

In the first embodiment, the interactive versatile AI, such as the Chat-GPT (trademark) is used, but it may also be possible to uniquely prepare a dedicated AI by machine learning.

To detect an event in the analysis screen (Step S602), for example, a DNN (Deep Neural Network) is used to prepare training data by using a feature of the analysis screen as an explanatory variable and using the presence or absence of a malware-derived event as a response variable, and a function approximator is generated by machine learning.

To acquire malware information inferred from the analysis screen including the event (Step S604), the training data is prepared by, e.g., using the feature of the analysis screen as the explanatory variable and using the malware information as the response variable, and the function approximator is generated by machine learning.

Note that Step S602 and Step S604 may also be performed as one step of acquiring the malware information including the presence or absence of the malware by using the same function approximator.

To extract only an operation procedure related to malware execution from the malware information (Step S605), the training data is prepared by, e.g., using the feature of the malware information as the explanatory variable and using the operation procedure related to the malware execution as the response variable, and the function approximator is generated by machine learning.

Note that Step S602, Step S604, and Step S605 may also be performed as one step by using the same function approximator. At this time, the function approximator is generated by machine learning using the feature of the analysis screen as the explanatory variable and using the operation procedure related to the malware execution as the response variable.

By mounting the function approximator thus generated in, e.g., the memory 120, it is possible to implement the same function as that in the first embodiment by using the function approximator instead of the interactive generative AI of the LLM server 111. At this time, to efficiently perform DNN calculation, the automatic analysis device 110 preferably includes a GPU (Graphics Processing Unit) as hardware.

As described above, the malware analysis system in the embodiment acquires the analysis screen in the malware analysis environment in which the malware was executed, determines whether or not the event corresponding to the analysis screen is the malware-derived event, generates the malware information related to the analysis screen, generates the operation procedure related to the malware information, references the code table determined in advance to transform the operation procedure to the code corresponding to the operation procedure, applies the code to the template to generate the automation program for the malware analysis, and executes the automation program to automatically operate the reaction required by the malware.

According to the embodiment described above, it is possible to precisely acquire the requested reaction for the malware-derived GUI that requests a wide variety of reactions from the user, automatically operate the appropriate reaction, and implement efficient malware protection. This can not only prevent fraudulent activities, but also reduce energy consumption and carbon emissions, prevent global warming, and contribute to the implementation of a sustainable society.

It should be noted that the present invention is not limited to the embodiments described above, and includes various modifications. For example, the embodiments described above have been described in detail to simply describe the present invention, and are not necessarily required to include all the described configurations. In addition, part of the configuration of one embodiment can be replaced with the configurations of other embodiments, and in addition, the configuration of one embodiment can also be added with the configurations of other embodiments. In addition, part of the configuration of each of the embodiments can be subjected to addition, deletion, and replacement with respect to other configurations.

### REFERENCE SIGNS LIST

100: malware analysis system,
110: automatic analysis device,
111: LLM server,
112: malware operation device,
113: network,
120: memory,
121: storage device,
122: network interface,
123: processor,
124: communication path,
125: input/output device,
130: screen acquisition unit,
131: event recognition unit,
132: content comprehension unit,
133: procedure extraction unit,
134: code generation unit,
135: coordinate acquisition unit
140: execution history table,
141: prompt table,
142: code table,
143: icon table

What is claimed is:

1. A malware analysis system comprising:
a screen acquisition unit, an event recognition unit, a content comprehension unit, a procedure extraction unit, and a code generation unit that are implemented by a CPU; and
an execution history table and a code table that are held by a storage unit,
wherein the code table holds a code required for malware execution and corresponding to a behavior pattern and a variable,
wherein, when acquiring an analysis screen to be analyzed, the screen acquisition unit stores the acquired analysis screen and an acquisition time thereof in the execution history table,
wherein the event recognition unit references the execution history table to acquire information indicating whether or not an event corresponding to the analysis screen stored by the screen acquisition unit is a malware-derived event, and notifies the content comprehension unit when the event is the malware-derived event,
wherein, when receiving the notification from the event recognition unit, the content comprehension unit acquires an analysis screen corresponding to the notification from the execution history table, acquires malware information related to the acquired analysis screen, and stores the acquired malware information in the execution history table,
wherein the procedure extraction unit acquires the malware information from the execution history table, acquires an operation procedure related to the acquired malware information, and stores the acquired operation procedure in the execution history table, and
wherein the code generation unit acquires the operation procedure from the execution history table, references the code table to transform the acquired operation procedure to a code corresponding to the operation procedure, and applies the code resulting from the transformation to a template to generate an automation program for malware analysis.

2. The malware analysis system according to claim 1, further comprising:
a coordinate acquisition unit that is implemented by the CPU,
wherein the operation procedure includes a behavior pattern and a variable,
wherein, when the variable of the operation procedure indicates a position, the coordinate acquisition unit acquires coordinates of the position, and outputs the acquired coordinates to the code generation unit, and
wherein the code generation unit transforms the operation procedure to a code including the coordinates acquired from the coordinate acquisition unit.

3. The malware analysis system according to claim 2,
wherein, when the variable of the operation procedure contains a character string, the coordinate acquisition unit recognizes and extracts the character string to acquire the coordinates, and
wherein, when the variable of the operation procedure contains no character string, the coordinate acquisition unit recognizes and extracts a predetermined image to acquire the coordinates.

4. The malware analysis system according to claim 1,
wherein the execution history table holds the acquired analysis screen, the acquisition time thereof, the malware information, and the operation procedure in an outputtable state.

5. The malware analysis system according to claim 1,
wherein an inference unit that outputs a result of analyzing a predetermined input is usable,
wherein the event recognition unit inputs, to the inference unit, information derived from the analysis screen stored by the screen acquisition unit to acquire information indicating whether or not the event corresponding to the analysis screen stored by the screen acquisition unit is the malware-derived event,
wherein the content comprehension unit inputs, to the inference unit, the information derived from the analysis screen stored by the screen acquisition unit to acquire the malware information related to the acquired analysis screen, and
wherein the procedure extraction unit inputs, to the inference unit, the malware information related to the acquired analysis screen to acquire the operation procedure related to the acquired malware information.

6. The malware analysis system according to claim 5,
wherein, as the inference unit, an interactive generative AI is usable,
the malware analysis system further comprising:
a prompt table to be stored in the storage unit,
wherein the event recognition unit acquires a first prompt from the prompt table, inputs the first prompt to the interactive generative AI, and acquires, as an answer from the interactive generative AI, information indicating whether or not the event corresponding to the analysis screen stored by the screen acquisition unit is the malware-derived event,
wherein the content comprehension unit acquires a second prompt from the prompt table, inputs the second prompt to the interactive generative AI, and acquires, as an answer from the interactive generative AI, the malware information related to the acquired analysis screen, and
wherein the procedure extraction unit acquires a third prompt from the prompt table, inputs the third prompt to the interactive generative AI, and acquires, as an answer from the interactive generative AI, the operation procedure related to the acquired malware information.

7. The malware analysis system according to claim 5,
wherein, as the inference unit, a function approximator mounted in the storage unit is used, and
wherein the function approximator is caused to respond to inputs from one or more of the event recognition unit, the content comprehension unit, and the procedure extraction unit.

8. A malware analysis method using:
a screen acquisition unit, an event recognition unit, a content comprehension unit, a procedure extraction unit, and a code generation unit that are implemented by a CPU; and
an execution history table and a code table that are held by a storage unit,
the malware analysis method comprising:
causing the code table to hold a code required for malware execution and corresponding to a behavior pattern and a variable;
causing the screen acquisition unit to store, when acquiring an analysis screen to be analyzed, the acquired analysis screen and an acquisition time thereof in the execution history table;
causing the event recognition unit to reference the execution history table to acquire information indicating whether or not an event corresponding to the analysis screen stored by the screen acquisition unit is a malware-derived event, and notify the content comprehension unit when the event is the malware-derived event;
causing the content comprehension unit to acquire, when receiving the notification from the event recognition unit, an analysis screen corresponding to the notification from the execution history table, acquire malware information related to the acquired analysis screen, and store the acquired malware information in the execution history table;
causing the procedure extraction unit to acquire the malware information from the execution history table, acquire an operation procedure related to the acquired malware information, and store the acquired operation procedure in the execution history table; and
causing the code generation unit to acquire the operation procedure from the execution history table, reference the code table to transform the acquired operation procedure to a code corresponding to the operation procedure, and apply the code resulting from the transformation to a template to generate an automation program for malware analysis.

9. The malware analysis method according to claim 8,
further using a coordinate acquisition unit that is implemented by the CPU,
wherein the operation procedure includes a behavior pattern and a variable,
wherein, when the variable of the operation procedure indicates a position, the coordinate acquisition unit acquires coordinates of the position and outputs the acquired coordinates to the code generation unit, and
wherein the code generation unit transforms the operation procedure to a code including the coordinates acquired from the coordinate acquisition unit.

10. The malware analysis method according to claim 8,
wherein an inference unit that outputs a result of analyzing a predetermined input is usable,
wherein the event recognition unit inputs, to the inference unit, information derived from the analysis screen stored by the screen acquisition unit to acquire information indicating whether or not the event corresponding to the analysis screen stored by the screen acquisition unit is the malware-derived event,
wherein the content comprehension unit inputs, to the inference unit, the information derived from the analysis screen stored by the screen acquisition unit to acquire the malware information related to the acquired analysis screen, and
wherein the procedure extraction unit inputs, to the inference unit, the malware information related to the acquired analysis screen to acquire the operation procedure related to the acquired malware information.
